(19) United States
(12) Patent Application Publication
(10) Pub. No.: US 2019/0063871 A1
(43) Pub. Date: Feb. 28, 2019

(54) SLIDING GUN SAFE PANEL

(71) Applicants: Neal Cain, Dohlonega, GA (US); Mike Nussbaum, Waveland, MS (US)

(72) Inventors: Neal Cain, Dohlonega, GA (US); Mike Nussbaum, Waveland, MS (US)

(21) Appl. No.: 15/686,128

(22) Filed: Aug. 24, 2017

(51) Int. Cl. F41C 33/06; E05G 1/024

(52) U.S. Cl. CPC F41C 33/06; E05G 1/06; E05G 1/024

(57) ABSTRACT

A sliding gun safe panel having firearm supports on each face of the panel and a slide mechanism that allows the panel to be moved out of the gun safe to unrestricted access to any firearm stored on either side of the sliding gun safe panel.

### BACKGROUND

The first rule of firearm safety is “proper gun control”, this rule is equally applicable when aiming and preparing to fire weapon as it is when storing a weapon for a period of time. It is the responsibility of gun owners to secure their firearms to protect children or inexperienced adults; and to keep firearms out of the hands of criminals in the event of theft.

Cables and trigger locks are an inexpensive way to keep children safe from unattended firearm access; however criminals will simply carry the disabled firearm away and remove the lock later using cutting tools. Using a quality gun safe is by far the best solution for securing firearms. Gun safes vary allowing a user to safely store single firearms in a pistol safe which should be permanently attached to a wall or a floor, or multiple firearms may be secured within a large standup safe. Large standup safes may be configured to securely store twenty or more long guns and additional hand guns and ammunition.

Most standup safes are configured to store the long guns with the butt-stock standing on the gun safe floor and the gun barrel restrained within a padded slot formed in a barrel support rack. In some configurations butt-stock indentations are formed having the same spacing as the slots in the barrel support rack and configured to keep the long guns separated to prevent bumping and scratching the valuable and sometimes artistic firearms. Large high capacity standup gun safes will include a gun rack along the back wall and possibly the side walls of the gun safe but may also include one or more additional rows of racking positioned in front of the back wall rack. This configuration allows for effective use of the gun safe floor space but presents a problem when a user desires to remove a long gun that is stored along the back wall of the safe. In most cases it is necessary to remove all of the firearms that are stored in front of that position on the back wall rack before the back gun can be removed. In some cases the user may attempt to slide the long gun between the forward positioned firearms; which may result in damage or possible optical sight misalignment to both the gun being removed and the firearms contacted.

What is needed is an improved storage rack system that allows for maximum usage of the standup gun safe floor space and for the easy removal of any firearm stored within the safe, regardless of the position where the firearm is stored.

### SUMMARY OF THE INVENTION

The disclosure of the present invention relates to a SLIDING GUN SAFE PANEL configured having firearm supports on each face of the panel and a slide mechanism that allows the panel to be moved out of the gun safe in a direction substantially perpendicular to the door opening. This arrangement allows a user unrestricted access to any firearm stored on either side of the sliding gun safe panel.

One embodiment of the present invention or sliding gun safe panel consisting of a planer panel having at least one gun support bracket on at least one face of the panel, and a sliding mechanism which allows the panel to be moved into and out of a standup gun safe. The panel having a height to fit into the door of the standup gun safe and the depth of the panel is determined by the depth of the gun safe and a reasonable allowance for the intrusion of the gun safe door. In a first embodiment the panel has a rectangular shape but in another embodiment the panel may be square, a trapezoid or the front or back edge of the panel may include one or more cutouts to accommodate anomalies such as, dehumidifier elements on the back surface of the safe, and pouches, racks or trays that are attached to the safe door.

In one embodiment the roller slide mechanism is attached to one side of the panel proximate the top edge of the panel. The roller slide mechanism having a slide support bracket attached to the upper interior surface of the gun safe or the slide support bracket is attached to the bottom surface or an interior shelf of the gun safe. The slide support bracket can be configured as piece of angular steel or aluminum or may be a c-shaped channel section. The base portion of a roller slide or drawer slide can be attached to the slide support bracket and a slide bar is attached to surface of the panel. The roller slide also including an intermediate slide section that provides a bearing surface for the slide bar and cantilevered support of the panel. In yet another embodiment a second slide mechanism can be attached to the side of the panel opposite the first slide mechanism in order to provide additional support where a panel may have an extended depth or where it is expected the panel is required to support a large number or heavy firearms.

In another embodiment the sliding gun safe panel may include a lower alignment guide configured as opposing structural angles being attached to the inside floor of the gun safe and have vertical flanges which constrain the sliding panel in a vertical orientation. The lower alignment guide may also be constructed using a single piece c-shaped channel having sufficient width to constrain the panel in a vertical orientation but having clearance allowing the panel to slide out of the gun safe door opening. In yet embodiment it is contemplated that a lower bearing or bearing surface may be used to displace excess weight away from the slide mechanism and allow for smooth panel actuation.

One embodiment of the sliding gun panel includes a gun support bracket configured as a vertical gun hanger or a vertical gun rack. The vertical gun hanger or rack including a vertical member having a rigid loop or hook attached at the top end which can securely wrap around the barrel or fore stock of a long gun or the barrel and/or barrel and slide of pistol; a second hook mechanism extends away substantially perpendicular from the bottom portion of the vertical member configured to extend through the trigger guard of a firearm or, in some instances may be inserted into the magazine well of the firearm for support. The vertical gun hanger may be constructed of a material such as aluminum or steel and then coated with a rubber, silicon or plastic material in order to protect the firearms. It is contemplated the gun hanger may also be injection molded using a material such as a fiber filed polypropylene, nylon or similar material. The fiber fill may include fiberglass, aramid or graphite. In one embodiment the lower member may also include a secondary bend or hook in order to more securely support a firearm. The length of the vertical member can vary in order to best support long guns, bull pup configured weapons and pistols. The vertical gun hangers may include holes extending through the vertical member allowing a user to attach the hanger to the sliding panel using screws or a similar fastener.

In yet another embodiment the gun support bracket may be a traditional rack configured having a bottom shelf to support the butt stock of long guns and a barrel support having slots to prevent the guns from shifting laterally. It may also be necessary that a retainer strap or bar is used to keep the guns in the upper rack barrel slots.

It is contemplated that a sewn panel or a plurality of gun sleeves may also be used to support firearms on the sliding panel.

### BRIEF DESCRIPTION OF DRAWINGS

The following description of the embodiments can be understood in light of the Figures which illustrate specific aspects of the embodiments and are part of the specification. Together with the following description, the Figures demonstrate and explain the principles of the embodiments. In the Figures the physical dimensions of the embodiment may be exaggerated for clarity. The same reference numerals or word descriptions in different drawings represent the same element, and thus their descriptions may be omitted.

FIG. 1 is a perspective view of a sliding gun safe panel,

FIG. 2 is a perspective view of a sliding gun safe panel having a gun support bracket,

FIG. 3 is a perspective view of a sliding gun safe panel having a gun support sleeve assembly,

FIG. 4 is a perspective view of one embodiment of a gun support bracket configured for long guns, and,

FIG. 5 is a perspective view of another embodiment of a gun support bracket configured for pistols.

It is to be understood that the above mentioned arrangements are only illustrative of the application of the principles of the present disclosure. Numerous modifications or alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

### DETAILED DESCRIPTION OF THE DRAWINGS

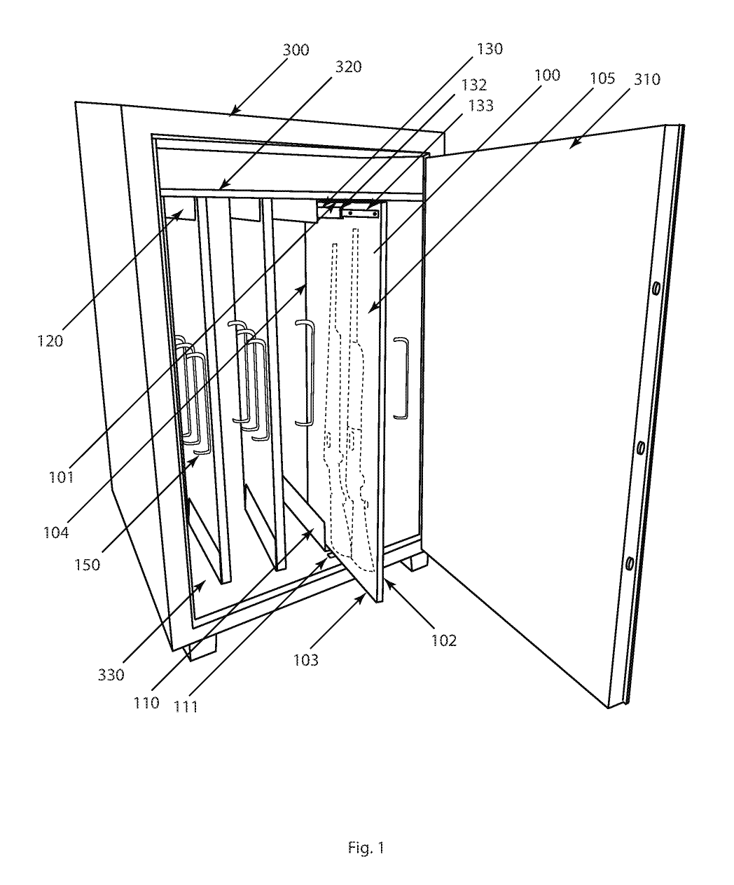

FIG. 1 is a perspective view of a gun safe 300 including one embodiment of a sliding panel 100. Gun safe 300 includes a door assembly 310, upper shelf 320 and a safe floor 330. Sliding panel 100 may be a planar rectangular shape configured to fit inside of the envelope of gun safe 300 having a top edge 101, front edge 102, bottom edge 103, back edge 104, a front surface 105 and a back surface 106. The sliding panel 100 is a rigid material of sufficient thickness to receive screws or other fasteners; panel 100 may be covered with a padded material such as carpeting, cloth or leather for ornamentation and protection of the firearms. An upper slide support bracket 120 may be attached to the interior ceiling of safe 300 or to the underside of an interior shelf 320. The base portion 131 (not shown) of roller slide 130 is attached to the inside vertical surface of the slide support bracket 120 with a slide bar portion 133 attached to the sliding panel 100 proximate the top edge 101, and intermediate slide section 132 extends out of the base section 131 and provides cantilevered support of panel 100. The bottom edge 103 of panel 100 may be constrained within a lower alignment guide 110 which is formed as two pieces of structural angle or a c-shaped structural channel. It is contemplated that a lower bearing 111 may be added, in front of or within the channel formed by alignment guide 110 to improve support and operation of sliding panel 100. The lower bearing 111 may be a roller bearing a simple bearing block comprising a material such as HDPE or nylon. Gun support brackets 150 may be mounted on both the front 105 and back 106 surfaces of panel 100.

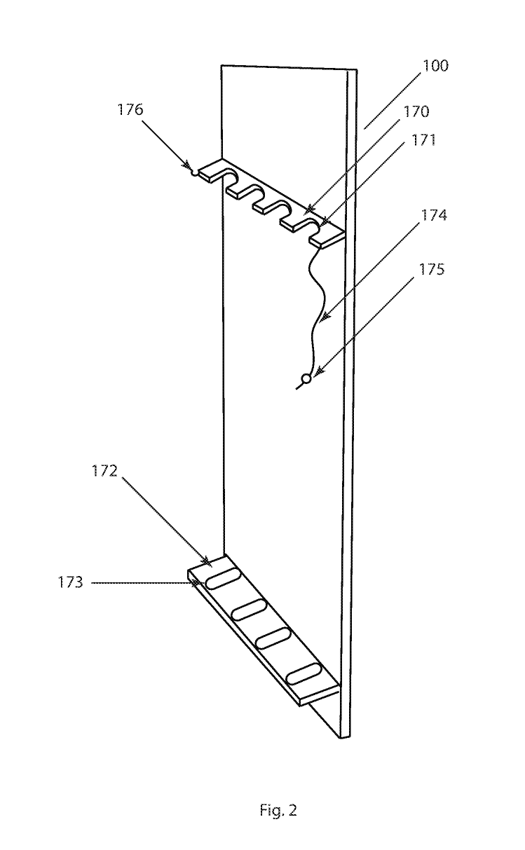

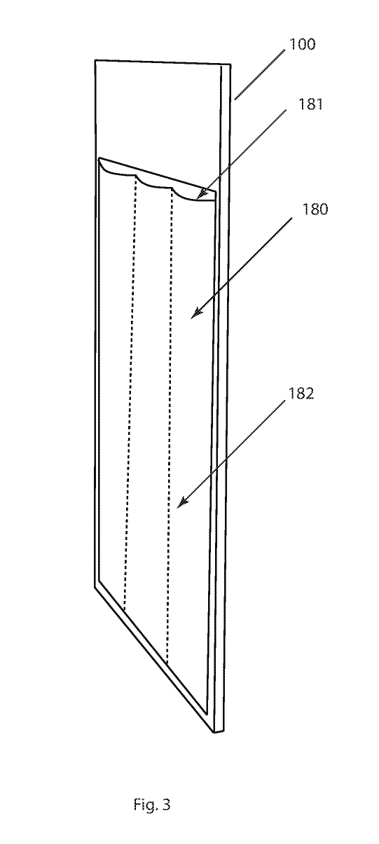

FIGS. 2 and 3 are additional embodiments of the present invention or sliding gun safe panel 100 wherein FIG. 2 depicts the panel 100 having a traditional gun rack 170 comprising an upper support bracket 177 having barrel alignment slots 171 and base portion 172. Long guns can be positioned in the rack with the butt stock resting on the base portion 172 with alignment guides depressions 173 and the barrel or fore stock resting within the barrel alignment slots 171. As panel 100 is moveable, it is contemplated that a barrel retention strap 174 with an attachment mechanism 175 and reciprocal latch 176 may be used to keep the firearms securely in place. Panel 100 shown in FIG. 3 depicts a soft or fabric panel 180 having a plurality of gun sleeves 181 sewn 182 into the panel 180. Panel 180 may include additional pockets or pouches configured to handle pistols, ammo or other shooting accessories.

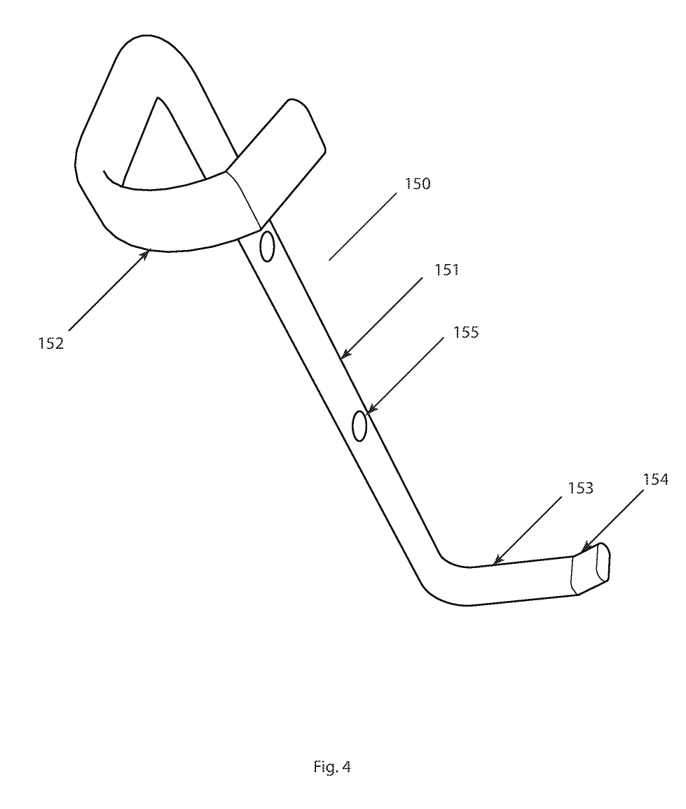

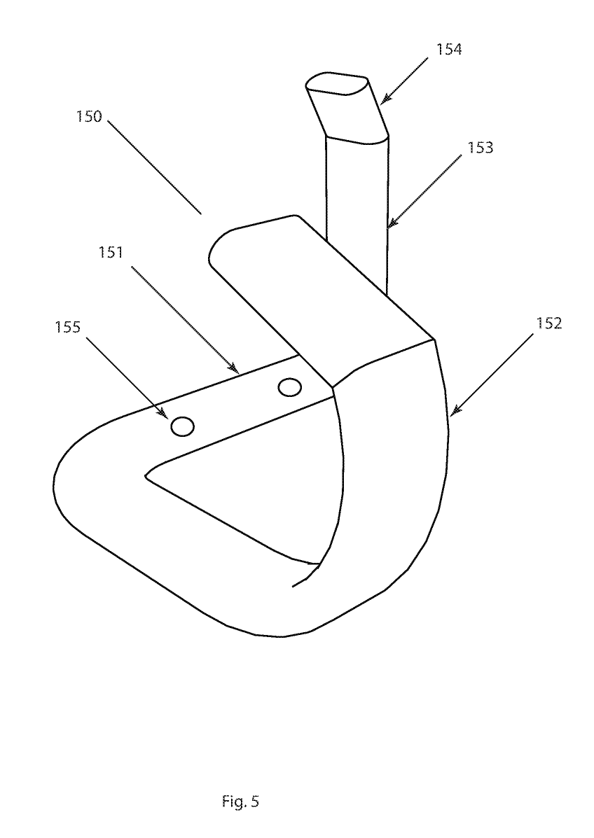

FIGS. 4 and 5 show gun support brackets 150 configured to support an individual firearm in a vertical position. As shown in FIG. 4 the longer bracket 150 is configured to support long guns, whereas the bracket 150 of FIG. 5 is configured to support pistols. Gun support bracket 150 comprising a vertical support member 151 having a barrel retaining loop 152 on the upper end and a trigger guard support 153 on the lower end of the support member 151.

Attachment holes 155 allow the user to secure gun support bracket 150 to sliding panel 100 using screws or another suitable fastener. In yet another embodiment the trigger guard support 153 may have a hook portion 154 to more securely support the firearm within the trigger guard or within the magazine well.

1. A sliding gun safe panel comprising,
a gun safe,
a panel
a slide assembly,
the slide assembly forming a moveable attachment between the gun safe and the panel,
a gun support bracket,
the gun support bracket having,
an extended vertical support member,
a barrel retaining loop formed on the upper end of the vertical support member, and,
a trigger guard support formed on the lower end of the vertical support member,
the gun support bracket mounted to the panel,
the gun support bracket is configured to support a gun vertically against the panel, and,
the panel configured to moveably slide from fully inside of the gun safe to at least partially outside of the gun safe.

2. The sliding panel of claim 1, wherein the panel moves linear and extends outside of the gun safe.

3. (canceled)

4. The sliding panel of claim 1, wherein the slide assembly is supported by a slide support bracket.

5. The sliding panel of claim 1, wherein the sliding panel is rectangular.

6-13. (canceled).

14. The sliding panel of claim 1 wherein a gun support bracket is attached to both the front and back surfaces of the sliding panel.

15. The sliding panel of claim 1 including a lower alignment guide.

16. (canceled).
